(19) United States
(12) Patent Application Publication
(10) Pub. No.: US 2013/0311151 A1
(43) Pub. Date: Nov. 21, 2013

(54) EARTH MODEL ESTIMATION THROUGH AN ACOUSTIC FULL WAVEFORM INVERSION OF SEISMIC DATA

(71) Applicant: René-Edouard André Michel Plessix, Voorburg (NL)

(72) Inventor: René-Edouard André Michel Plessix, Voorburg (NL)

(21) Appl. No.: 13/876,139

(22) PCT Filed: Sep. 27, 2011
(86) PCT No.: PCT/EP11/66735

§ 371 Date: Mar. 26, 2013

(30) Foreign Application Priority Data
Sep. 28, 2010 (EP) 10181006.7

(51) Int. Cl. G06F 17/50

(52) U.S. Cl. CPC G06F 17/5009
USPC 703/2; 703/6

(57) ABSTRACT

An improved method of estimating an earth model utilizes an acoustic Full Waveform Inversion (FWI) of seismic data in a pseudo-time coordinate system, in which the earth model m(\tilde{m}) is parameterized with two lateral coordinates (x,y) and a vertical coordinate (\tilde{z}) which expresses vertical travel time of acoustic signals used to generate the seismic data.

### BACKGROUND OF THE INVENTION

The invention relates to a method for estimating an earth model using acoustic full waveform inversion of seismic data.

Full Waveform Inversion (FWI) of seismic data helps improving the macro velocity model under acoustic vertical transversely isotropic assumption.

Nevertheless, Full Waveform Inversion (FWI) suffers from the depth/velocity ambiguity because the model parameters are naturally represented in the spatial depth coordinate system.

Full waveform inversion (FWI) automatically determines an earth model by minimizing the misfit between modelled and observed data. The minimization is solved with a local optimization technique with real-sized applications. This requires an initial guess.

One of the main difficulties with full waveform inversion (FWI) is the presence of local minima. These local minima appear when the modelled data and the observed data are out of phase.

Commonly, the earth model (m) is parameterized with two lateral spatial coordinates (x,y) and the depth coordinate (z). This (x,y,z) system is known as the depth coordinate system.

However, there is an ambiguity between depth (z) and vertical acoustic velocity. This can make full waveform inversion (FWI) in the depth coordinate system (x,y,z) ambiguous.

From an inverse problem point of view, this means that the problem is ill posed. This is especially true when the initial earth model (m) contains hard contrasts. Indeed, a modification of the earth model (m) above the hard contrasts can significantly change the time response of the reflected events and create a large phase error between the modelled and the observed data.

This ambiguity can be reduced when the earth model (m) is parameterized with two lateral spatial coordinates (x,y) and the vertical time coordinate (\tilde{z}). Such a system is called a pseudo-time coordinate system. This is classically used in time processing, for instance in time migration, and in visualization of migrated sections.

However, time processing assumes mild lateral velocity variations. This assumption is not satisfied in complex geological settings and therefore classic automatic velocities are formulated in the depth coordinate system.

To prevent full waveform/wavefield inversion from ending up in a local minimum, the best practice is to implement a multiscale approach. The multiscale approach consists of first decomposing the observed data in frequency bands, secondly starting the inversion with the band containing the lowest frequencies, and then slowly increasing the frequency content of the observed data.

This approach is quite successful when inverting the transmitted (diving/refracted) waves of the data.

However, when the earth model is parameterized in the depth coordinate, it does not prevent the occurrence of phase mismatches between the late events, generally reflected events of the modelled and observed data.

To overcome this problem a manual layer stripping approach can be applied. It consists of applying full waveform inversion to obtain the shallow part of the model, then correcting the deeper part of the model with traditional methods, such as travel time inversion, to correct the large phase errors between modelled and observed data, and then to reapply full waveform inversion. Several iterations between full waveform inversion and traditional (manual) techniques can be necessary.

The formulation of full waveform inversion in the Laplace-Fourier domain may also help avoiding local minima. However, this approach is also formulated in the depth coordinate system and therefore inherently suffers from the depth/velocity ambiguities. The formulation in the Laplace-Fourier domain may however allow avoiding the traditional (manual) techniques.

A list of patents and other prior art references relating to earth model parameterization and earth model estimation using (acoustic) Full Waveform Inversion is provided below:
U.S. Pat. No. 6,999,880: Source-independent full waveform inversion of seismic data; 2006, Author: Ki Ha Lee
U.S. Pat. No. 7,373,252: 3D pre-stack full waveform inversion; 2004, Authors: Martinez, R., Sun C.
U.S. Pat. No. 7,725,266: System and method for 3D frequency-domain waveform inversion based on 3D time-domain forward modelling; 2007, Authors: Sirgue, L., T. J. Etgen, U. Albertin, and S. Brandsberg-Dahl.
Alkhalifah, T. and I. Tsvankin, 1995. Velocity analysis for transversely isotropic media, Geophysics, 60, 1550-1566.
Alkhalifah, T., 2000. An acoustic wave equation for anisotropic media, Geophysics, 65, 1239-1250.
Alkhalifah, T., S. Fomel, and B. Biondi, 2001. The space-time domain: theory and modeling for anisotropic media, Geophysical Journal International, 144, 105-113.
Alkhalifah, T., 2003. Tau migration and velocity analysis: theory and synthetic examples, Geophysics, 68, 1331-1339.
Banik, N. C., 1984. Velocity anisotropy of shales and depth estimation in the North Sea basin, Geophysics, 49, 1411-1419.
Banik, N. C., 1986. An effective anisotropy parameter in transversely isotropic media, Geophysics, 52, 1654-1664.
Bickel, S. H., 1990. Velocity-depth ambiguity of reflection traveltimes, Geophysics, 55, 266-276.
G. Chavent and C. A. Jacewitz, 1995. Determination of background velocities by multiple migration fitting, Geophysics, 60, 476-490.
Chauris, H., and M. Noble, 2001. Two-dimensional velocity macro model estimation from seismic reflection data by local differential semblance optimization: applications synthetic and real data sets, Geophysical Journal International, 144, 14-26.
Clément, F., and G. Chavent, 1993. Waveform inversion through MBTT formulation, in Mathematical and Numerical Aspects of wave propagation (eds E. Kleiman, T. Angell, D. Coltron, F. Santosa, and I. Stakgold), SIAM, Philadelphia.
Doherty, S. M., and J. F. Claerbout, 1976. Structure independent velocity estimation Geophysics, 41, 850-881.
Duveneck, E., Milcik, P., P. Bakker, and C. Perkins, 2008. Acoustic VTI wave equations and their application for anisotropic reverse-time migration, in Proc. of the 78th SEG annual meeting, Las Vegas, Expanded Abstract, 2186-2190.
Gauthier O., A. Tarantola, and J. Virieux, 1986. Two-dimensional nonlinear inversion of seismic waveforms, Geophysics, 51, 1387-1403.
Lailly, P., 1983. The seismic problem as a sequence of before-stack migrations, in Conference on Inverse Scattering: Theory and applications, (ed J. Bednar), SIAM.
Lines, L., 1993. Ambiguity in analysis of velocity and depth: Geophysics, 58, 596-597.
Meng, Z. and Bleistein, N, 2001. On velocity/depth ambiguity in 3-D migration velocity analysis, Geophysics, 66, 256-260.
Mora, P., 1988. Elastic wavefield inverison of reflection and transmission data, Geophysics, 53, 750-759.
Plessix R.-E., Y.-H. de Roeck, and G. Chavent, 1999. Waveform inversion of reflection seismic data for kinematics parameters by local optimization, SIAM Journal on Scientific Computation, 20, 1033-1052.
Plessix, R.-E., 2006. A review of the adjoint-state method for computing the gradient of a functional with geophysical applications, Geophysical Journal International, 167, 495-503.
Plessix, R.-E., 2009. A Helmholtz iterative solver for 3D seismic-imaging problems, Geophysics, 72, SM185-194.
Plessix, R.-E., 2009. Three-dimensional frequency-domain full-waveform inversion with an iterative solver, Geophysics, 74, WCC141-157.
Plessix, R.-E., and C. Perkins, 2010. Full waveform inversion of a deep-water Ocean Bottom Seismometer data set, First Break, 28, 71-78.
Plessix, R.-E., and H. Rynja, 2010. VTI full waveform inversion: a parameterization study with a narrow azimuth streamer data example, Expanded Abstract, SEG Annual Meeting.
Pratt R. G., Z. Song, and M. Warner, 1996. Two-dimensional velocity models from wide-angle seismic data by wavefield inversion, Geophysical Journal International, 124, 323-340.
Pratt, R. G., C. Shin, G. J. Hicks, 1998. Gauss-Newton and full Newton methods in frequency-space seismic waveform inversion, Geophysical Journal International, 133, 341-362.
Pratt, R. G., and R. M. Shipp, 1999. Seismic waveform inversion in the frequency domain, part 2: fault delineation in sediments using crosshole data, Geophysics, 64, 902-914.
Ravaut C., S. Operto, S. Importa, J. Virieux, A. Herrero, and P. dell'Aversana, 2004,
Multi-scale imaging of complex structures from multi-fold wide-aperture seismic data by frequency-domain full-waveform inversions: application to a thrust belt, Geophysical Journal International, 159, 1032-1056.
Robein, E., 2003. Velocities, time-imaging and depth-imaging in reflection seismic, EAGE.
Shipp, R. M. and S. C. Singh, 2002. Two-dimensional full wavefield inversion of wide-aperture marine seismic streamer data, Geophysical Journal International, 151, 325-344.
Sirgue, L., O. I. Barkved, J. Dellinger, J. Etgen, U. Albertin and J. H. Kommedal, 2010.
Full waveform inversion: the next leap forward in imaging at Valhall, First Break, 28, 65-70.
Snieder, R., M. Y. Xie, A. Pica, and A. Tarantola, 1989. Retrieving both the impedance contrast and background velocity: A global strategy for the seismic reflection problem, Geophysics, 54, 991-1000.
Rathor, B. S., 1997, Velocity-depth ambiguity in the dipping reflector case, Geophysics, 62, 1583-1585.
Stork, C., 1992. Singular value decomposition of the velocity-refelctor depth tradeoff, Part 2: High-resolution analysis of a generic model, Geophysics, 57, 933-943.
Stork, C., and R. W. Clayton, 1992. Using constraints to address the instabilities of automated prestack velocity analysis, Geophysics, 57, 404-419.
Symes, W. W., and J. J. Carrazone, 1991. Velocity inversion by differential semblance optimization, Geophysics, 56, 654-663.
Symes, W. W., 2008. Migration velocity analysis and waform inversion, Geophysical Prospecting, 56, 765-790.
Tarantola, A., 1984. Inversion of seismic reflection data in the acoustic approximation, Geophysics, 49, 1259-1266.
Tarantola, A., 1987. Inverse problem theory, Elsevier.
Thomsen, L., 1986. Weak elastic anisotropy, Geophysics, 51, 1954-1966.
Yilmaz, O., 2001. Seismic data analysis, SEG.

It is observed that all the known approaches are formulated in the depth coordinate system.

Nevertheless, Snieder et al, 1989, and Pratt et al, 1998 already proposed a full waveform inversion that was partially parameterized in the pseudo-time coordinate system. However, in their approach only the reflectivity is parameterized in the pseudo-time coordinate system. The non-linear inversion is still carried out with a model parameterized in the depth coordinate system (as described in more detail in Appendix C).

Thus, there is a need to reduce the ill posedness of full waveform inversion associated with the known approaches, which formulate full waveform inversion in a depth coordinate systems.

The present invention therefore aims to make full waveform inversion more robust.

### SUMMARY OF THE INVENTION

In accordance with the invention there is provided a method of estimating an earth model through an acoustic full waveform inversion of seismic data in a pseudo-time coordinate system, in which the earth model is parameterized with two lateral coordinates and a vertical coordinate which expresses vertical travel time of acoustic signals used to generate the seismic data.

The seismic data may be surface seismic data and the horizontal coordinates may be expressed by the abbreviations x and y and the vertical coordinate which expresses the vertical travel time may be expressed by the abbreviation \tilde{z} and may be defined at each lateral position (x,y) by

$$\tilde{z} = {\int }_{{z}_{0}}^{z} \frac{d z}{{v}_{v} ( x , y , z )} ,$$

wherein:
vᵥ is a vertical velocity of the acoustic signals,
z is depth, and
z₀ is a depth origin.

The earth model may be expressed by the abbreviation m and may comprise a range of variables, such as nmo velocity, reflectivity, η, δ, ε VTI parameters density, vertical velocity, horizontal velocity, which are calculated by an iterative calculation that may comprise:

a) generating an initial earth model \tilde{m}
in the pseudo-time coordinate system;
b) iteratively looping over a series of scales provided by frequency bands of the seismic data;
c) looping over the iterative loops to obtain an adjusted earth model, \tilde{m}, with modelled data;
d) computing the modelled data;
e) evaluating a misfit functional between the modelled and observed data;
f) computing a gradient of the misfit functional with respect to the earth model \tilde{m}; and
g) updating the earth model \tilde{m} with a local optimization technique.

In one embodiment the foregoing steps c), d) and f) of the iterative calculation may further comprise:

c2) applying a change of variables between the pseudo-time coordinate system to a depth coordinate system to obtain an adjusted earth model, m(\tilde{m}), in depth, with modelled data;
d2) computing the modelled data by solving an acoustic vertical transversely isotropic wave equation in depth, optionally by applying equations A.1 or A.2 as described hereinbelow;
f2) computing the gradient of the misfit functional with respect to the earth model m by solving adjoint equations of the depth wave equation and correlating incident wave fields and adjoint wave fields; and
applying a change of variables between the depth coordinate system to the pseudo-time coordinate system to obtain a gradient in the pseudo-time coordinate system; and the method may further comprise:
g) using the gradient to update the earth model m in the pseudo-time coordinate system with a local optimization technique.

In an alternative embodiment, steps c) and f) of the iterative calculation further comprise:

c3) computing the modelled data by solving a pseudo-time wave equation on the basis of equation A.5 as described hereinbelow; and
f3) computing the gradient of the misfit functional with respect to the earth model by solving the adjoint equation of the pseudo-time wave equation and correlating the incident and adjoint wave fields.

The method according to the present invention differs from the methods disclosed in the prior art references because it formulates full waveform inversion in a pseudo-time coordinate system. Therefore the vertical time of the reflected events are better preserved. The formulation of the earth model in a pseudo-time coordinate system instead of the depth coordinate system will help:

1. To reduce the velocity/depth ambiguity of the depth formulation
2. To make more robust the inverse problem that is associated with full waveform/wavefield inversion
3. To avoid some of the local minima that occur in full waveform/wavefield inversion with the late (reflection) events.
4. To extend the depth of investigation of full waveform/wavefield inversion by reducing the loop skipping between the modelled and observed reflection events.

The method according to the invention may be used to make an accurate image, such as a seismic map, of a subsurface earth formation comprising a hydrocarbon fluid, such as crude oil and/or natural gas, which image or seismic map may be used to plan, manage and/or optimize the placement of at least one hydrocarbon fluid production well traversing the formation and/or the production of hydrocarbon fluid through the at least one well.

These and other features, embodiments and advantages of the method according to the invention are described in the accompanying claims, abstract and the following detailed description of non-limiting embodiments depicted in the accompanying drawings, in which description reference numerals are used which refer to corresponding reference numerals that are depicted in the drawings. Similar reference numerals in different figures denote the same or similar objects.

### BRIEF DESCRIPTION OF THE DRAWINGS

FIG. 1 shows the true velocity model used in Example 1.

FIG. 2 shows the initial velocity model used in Example 1.

FIG. 3 shows a synthetic shot generated with the true velocity model shown in FIG. 1.

FIG. 4 shows a synthetic shot generated with the true velocity model shown in FIG. 2.

FIG. 5 shows Comparison between the synthetic data generated with the true model (in black wiggles) and with the initial model (in black and white). The data are in phase when the black wiggle overlaid the white loop.

FIG. 6 shows how a velocity model is obtained after FWI starting with the true velocity model shown in FIG. 2.

FIG. 7 shows a synthetic shot generated with the velocity model retrieved by FWI from FIG. 6 to obtain modelled data.

FIG. 8 shows a comparison between the synthetic data generated with the true model shown in FIG. 2 (in black wiggles) and modelled data after FWI shown in FIG. 7 (in black and white). The data are in phase when the black wiggle overlaid the white loop.

FIG. 9 shows a velocity model in pseudo-time (a) and in depth (b) with a second layer at 2000 m/s.

FIG. 10 shows a velocity model in pseudo-time (a) and in depth (b) with a second layer at 2400 m/s, wherein the velocity change in the second layer was done in the pseudo-time model space. (The first layer is at 1500 m/s and is not real visible; it corresponds to the white zone on the top).

FIG. 11 shows a seismogram comparison after 20% velocity change in the second layer in the pseudo-time coordinate system. The shot gather computed in the velocity model as shown in FIG. 9 is in black wiggles and the shot gather computed in the perturbed velocity model as shown in FIG. 10 is in black and white. The data are in phase when the black wiggle overlaid the white loop.

FIG. 12 shows a velocity model in depth with a second layer at 2400 m/s. The velocity change in the second layer was done in the depth model space.

FIG. 13 shows a seismogram comparison after 20% velocity change in the second layer in the depth coordinate system. The shot gather computed in the velocity model, as shown in FIG. 9, is in black wiggles and the shot gather computed in the perturbed velocity model, as shown in FIG. 12, is in black and white. The data are in phase when the black wiggle overlaid the white loop.

FIG. 14 shows how velocity is obtained after pseudo-time FWI starting with the velocity model FIG. 2.

FIG. 15 shows a comparison of depth velocity profiles at x=15 km. The solid continuous line corresponds to the true model, the dotted line to the initial model, and the dotted-dashed line to the FWI velocity model, in the graph a after depth FWI and in graph b after pseudo-time FWI.

FIG. 16 shows a Comparison of pseudo-time velocity profiles at x=15 km. The solid continuous line corresponds to the true model, the dotted line to the initial model, and the black dotted-dashed line to the FWI velocity model after pseudo-time FWI.

FIG. 17 shows a synthetic shot generated with the velocity model retrieved by pseudo-time FWI as shown in FIG. 14.

FIG. 18 shows a comparison between the synthetic data generated with the true model (in black wiggles) and modelled data after pseudo-time FWI (in black and white). The data are in phase when the black wiggle overlaid the white loop.

FIG. 19 shows a true velocity and initial velocity for the second FWI example. The velocities are plotted in a logarithmic scale.

FIG. 20 shows how velocities are obtained after a depth FWI in graph a and a pseudo-time FWI in graph b. The velocities are plotted in a logarithmic scale.

FIG. 21 shows horizons where the velocity becomes larger than 3500 m/s. The dotted line corresponds to the initial model, the dotted-dashed line to the true model, the dashed line to the depth FWI result, and the solid continuous line to the pseudo-time FWI result.

### DETAILED DESCRIPTION OF THE DEPICTED EMBODIMENTS

Full waveform inversion of surface seismic data helps improving the macro velocity model under acoustic vertical transversely isotropic assumption. Nevertheless, full waveform inversion suffers from the depth/velocity ambiguity because the model parameters are naturally represented in the spatial depth coordinate system. With classic velocity analysis, a time processing in which vertical time replaces depth as vertical axis provides a more robust formulation. Classic time processing assumes mild lateral variations and does not apply to complex geological settings. To extend the time processing without the assumption of mild lateral variations, a change of variables based on the vertical velocity is performed. Applied directly to the wave equation, it leads to a modified wave equation in pseudo-time coordinate where depth is replaced by vertical time.

A pseudo-time formulation of full waveform inversion is therefore proposed to improve its robustness. This is especially important when the initial model parameter is derived from reflection data and contains large contrasts. The reformulated wave equation in pseudo-time however leads to a rather complicated implementation. A simpler approach consists of applying the change of variables at the level of the misfit functional and computing the gradient with the standard chain rules between the depth and pseudo-time coordinate systems. Synthetic examples illustrate the relevance of this new formulation of full waveform inversion. This pseudo-time reformulation could also be applied to any migration based velocity analysis.

Proposed in the nineteen eighties (Lailly 1983, Tarantola 1884, Gauthier et al. 1986, Tarantola 1987, Mora 1988, Snieder et al. 1989), full waveform inversion or full wavefield inversion (FWI) consists of deriving earth model parameters by minimizing the error misfit between computed data and observed data. Several authors have published significant results when applied to wide-aperture and low-frequency active seismic surface data (Pratt et al. 1996, Pratt and Shipp 1999, Shipp and Singh 2002, Ravaut et al 2004, Plessix 2009, Plessix and Perkins 2010, Sirgue et al. 2010). With large multi-source, multi-receiver data sets, due to computational costs, FWI is applied under the acoustic isotropic or acoustic vertical transversely isotropic (VTI) assumption and consequently only interprets the compressional body waves (P-waves). The goal is to determine the background velocity, namely the long spatial wavelengths of the velocity, by inverting the low frequencies of the surface seismic data. In all these applications, the earth parameters are generally represented in the depth coordinate system; this means that the vertical axis is depth. Initial earth parameter values are required because the error misfit is minimized with a local optimization technique. This initial guess should be good enough to avoid ending up in a local minimum.

During the inversion, the shallow part of the model is generally retrieved first. With the depth as vertical axis these shallow earth parameter modifications can cause the deeper events of the synthetic and observed data to become out of phase. If this happens, the inversion ends up in a local minimum and the deeper part of the earth model is not correctly updated. This behaviour more likely occurs when the initial earth model is found by reflection travel-time tomography.

This behaviour is known in classic reflection velocity analysis. In this way, several authors mentioned that velocity analysis in depth is less robust than in time because there is an ambiguity between velocity and depth (Bickel, 1990, Stork 1992, Stork and Clayton 1992, Lines 1993, Rathor 1997, Meng and Bleistein 2001). The ambiguity is even stronger in an anisotropic media (Banik 1984, 1986).

Classic time processing is however insufficient in complex geological settings because it assumes laterally invariant earth parameters and therefore it is valid only in regions exhibiting mild lateral variations (Yilmaz 2001, Robein 2003). Nevertheless, the idea of using vertical time (Doherty and Claerbout 1976) instead of depth as vertical axis in velocity analysis can be implemented without any assumption on the lateral variations of the earth parameters (Alkhalifah 2001, Alkhalifah et al., 2003). Indeed, an acoustic VTI wave equation with vertical time as vertical axis can be obtained by a change of variables involving the vertical velocity (Alkhalifah et al. 2001). Using this reformulated wave equation in vertical time the difficulty described above should be mitigated since the vertical times of the deeper events in the synthetics will not change even when the shallow velocity model is updated. Therefore, the deeper events in the modelled and observed data will stay in phase, at least at short offsets (assuming they were in phase in the initial guess).

Snieder et al., 1989, and Pratt et al., 1998, proposed a FWI formulation where the background velocity (the long wavelengths of the velocity) is parameterized in depth while the impedance (the short wavelengths of the velocity) is parameterized in vertical time. This formulation tries to decouple the background velocity and impedance and therefore reduces some of the nonlinearity of the data misfit functional. Here, one proposes to formulate all acoustic model parameters with the vertical time. This differs from the approach of Snieder et al., 1986, because the non-linear inversion is now also performed with the model parameterized with the vertical time. Formulating FWI with earth model parameters defined with the vertical time as vertical axis is called a pseudo-time formulation full waveform inversion. Solving the wave equation in vertical time and computing the associated gradient of the error misfit can however be cumbersome because the model parameter dependencies are more complicated than with the wave equation in depth. An alternative is to carry out the change of variables at the level of the error misfit. This implies computing the gradient with respect to the earth parameters defined in vertical time from the gradient with respect to the earth parameters defined in depth with the classical chain rules.

Sections I-V and Appendices A-D hereinbelow provide optional details, examples and aspects of the method according to the invention and are organized as follows:
I) In the first section (I), VTI FWI in depth is briefly presented, and a small synthetic example showing the difficulties of FWI in depth is discussed.
II) In the second section (II), VTI FWI in pseudo-time is briefly presented.
III) The third section (III) comprises EXAMPLE 1 in which a synthetic example is inverted in pseudo-time.
IV) The fourth section (IV) comprises EXAMPLE 2 in which a second FWI example in pseudo-time is shown.
V) Finally some conclusions are drawn in section (V); and Appendices A-D describe formula's that may be used in the method according to the invention.

### I) Vertical Transversely Isotropic (VTI) Full Waveform Inversion (FWI) in depth

At low frequencies, the main objective of full waveform inversion is to retrieve a (background) earth model that can be later used for imaging the earth discontinuities. In a vertical transversely isotropic model, the P-wave traveltimes are correctly parameterized with the NMO (normal moveout) velocity, vₙ, and the η parameter (Alkhalifah and Tsvankin 1995). We could also use the horizontal velocity since vₕ=\sqrt{1+2η}vₙ.

While not physical, an acoustic VTI wave equation is obtained by zeroing the shear modulus (Alkhalifah 2000, Duveneck et al. 2008). Writing this wave equation in terms of vₙ, η, leads to (see Appendix A)

$$\begin{matrix}\{ \begin{matrix}\frac{1}{ρ {v}_{n}^{2}} {\partial }_{tt} {p}_{n} - ( {\partial }_{x} \frac{1}{ρ} {\partial }_{x} {p}_{h} + {\partial }_{y} \frac{1}{ρ} {\partial }_{y} {p}_{h} ) - \frac{1}{\sqrt{1 + 2 δ}} {\partial }_{z} \frac{1}{ρ} {\partial }_{z} \frac{{p}_{n}}{\sqrt{1 + 2 δ}} = s \\ \frac{1}{ρ {v}_{n}^{2}} {\partial }_{tt} {p}_{h} - ( 1 + 2 η ) ( \begin{matrix}{\partial }_{x} \frac{1}{ρ} {\partial }_{x} {p}_{h} + \\ {\partial }_{y} \frac{1}{ρ} {\partial }_{y} {p}_{h}\end{matrix} ) - \frac{1}{\sqrt{1 + 2 δ}} {\partial }_{z} \frac{1}{ρ} {\partial }_{z} \frac{{p}_{n}}{\sqrt{1 + 2 δ}} = s\end{matrix} & ( 1 )\end{matrix}$$

Here, the quantities depend on x, the coordinate vector formed with the two lateral coordinates and the depth coordinate; s is the source term; pₙ and pₕ are the “nmo (normal move-out)” and “horizontal” pressures, with pₙ\sqrt{1+2δ} pᵥ and pᵥ the “vertical” pressure; vₙ is the nmo velocity; ρ the density; and η and δ the VTI Thomsen's parameters (Thomsen 1986).
The synthetics, c, are given by

c=S(aₕpₕ+aₙpₙ) (2)

with S a sampling operator and aₙ+aₕ=1. The acoustic VTI wave equations are not physical wave equations, since anisotropy does not exist in acoustic medium. However, it allows us to take into account anisotropy effects in P-wave propagation. We notice that pₙ=pₕ in an isotropic region. With the source and receivers in an isotropic region, we can choose aₙ=aₕ=½ or aₙ=1, aₕ=0.

Given an observed data d, the least-squares misfit functional, J, is

J(m)=½∥W(c−d) (3)

Regularization terms could be added. Here, W is the data weighting matrix; the earth parameters, m, are vₙ, η, δ, and ρ; and c and d are multi-source and multi-receiver data sets. The norm ∥·∥ can be the least-square (L2) criterion, the least-norm (L1) criterion, or any other criterion.

During FWI, J is minimized to retrieve the earth parameters. Because solving the wave equations is expensive, only a local optimization technique is used. At the iteration k, a quasi-Newton update reads:

mₖ₊₁=mₖ−αkβₖ∇ₘJ(mₖ) (4)

with αₖ the step length and Bₖ an approximation of the inverse of the Hessian of J. Bₖ can be partially seen as a depth weighting matrix or a preconditioning matrix.

The gradient ∇ₘJ is computed with the adjoint-state method (Plessix 2006).

This approach is sensitive to the initial earth model, m₀, and can end up in a local minimum (Plessix 2009). To mitigate the sensitivity to the initial model, a multiscale approach is used (Pratt et al. 1996). This means that the low frequencies of the data sets are inverted first. Because FWI preferentially updates the long spatial wavelengths of the velocity from the direct, diving, and refracted waves, the initial velocity model should a priori model first breaks that are in phase, within half a period, with the observed first breaks, namely the synthetic and observed data are in phase at long offsets. This may be achieved by refraction traveltime inversion. However, in exploration geophysics with active surface data, velocity model building is most of the time based on reflection data. Starting FWI with the velocity model derived from reflection data means that the reflected events between the observed data and the modelled data are in phase; the observed and modelled data are in phase at short offsets. FWI updates the velocity by interpreting both the reflected and refracted/diving waves, namely the full wavefield. In this way, more details can be retrieved. One of the main difficulties in FWI is the presence of loop skipping that creates local minima in the misfit functional.

During the iterative optimization process, two events that were in phase may become out of phase and the minimization of J can end up in a local minimum. This can happen with reflection events when the velocity above the reflectors causing these reflection events changes. Because the waves first see the shallow part of the earth, FWI has tendency to update the velocity model in a kind of layer stripping mode, depending on the preconditioning approach. The velocity update in the shallow part, where the refracted/diving waves propagate, is also often emphasized because FWI works in a tomographic mode in presence of those waves and consequently updates the long wavelengths of the velocity. When starting the optimization with a velocity model derived from reflection data, the velocity update in the shallow part may therefore introduce a phase shift between the late reflected events of the observed and modelled data. If this occurs, FWI may have difficulty to converge and may damage the interpretation of the reflections.

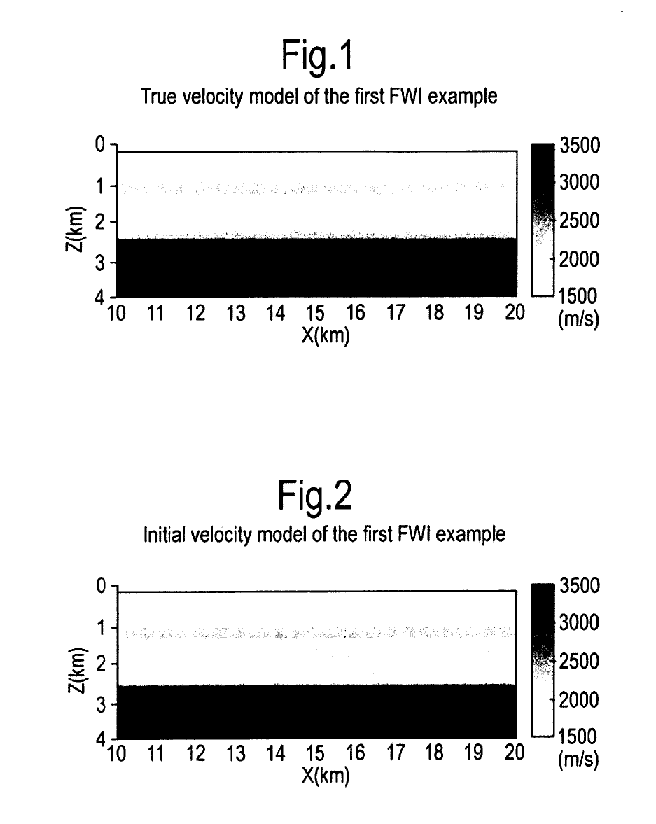

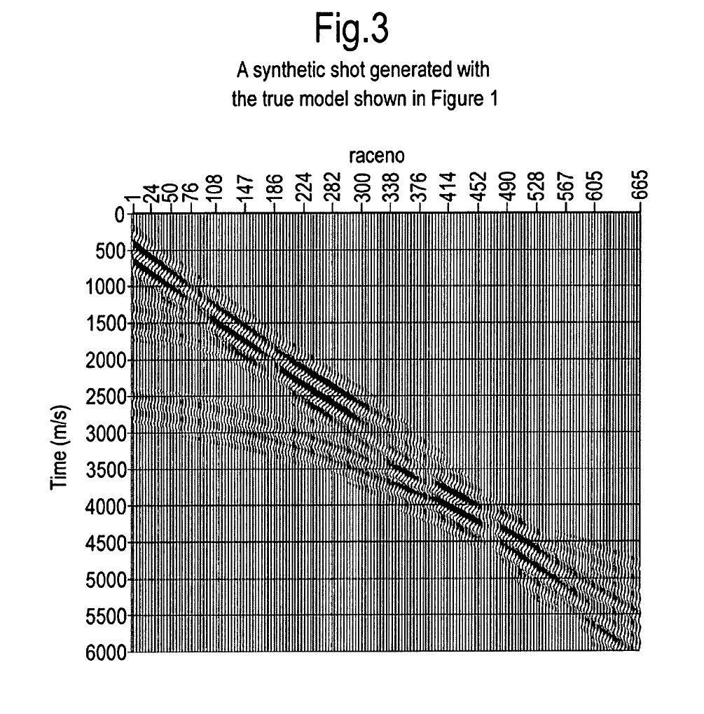

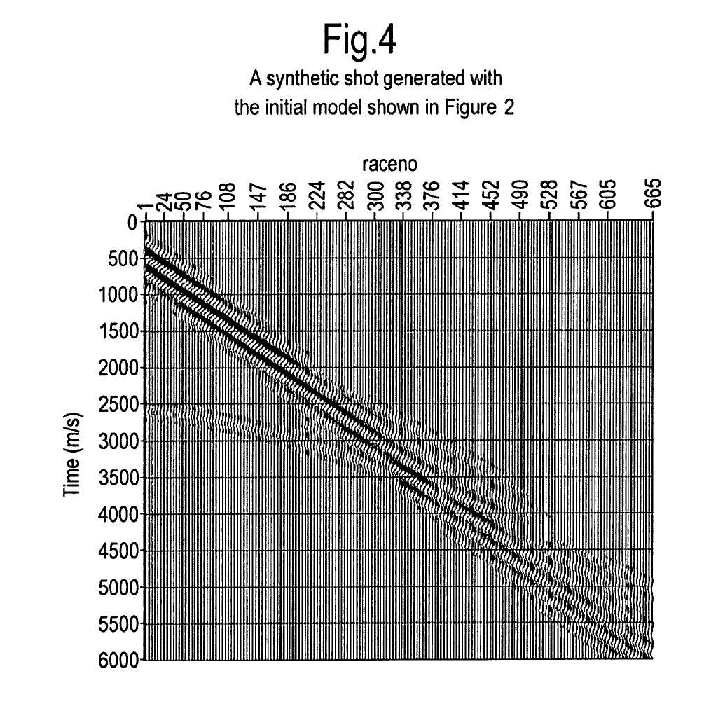

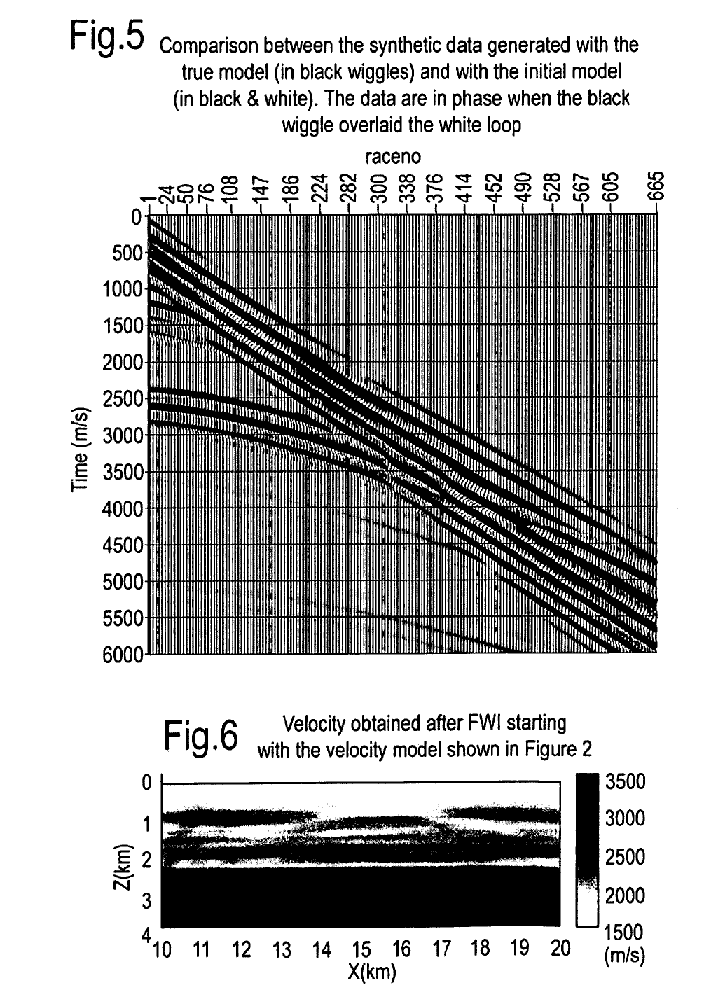

To illustrate this behaviour, we generated a data set using the (true) velocity model, FIG. 1, with a 2D marine acquisition. The data set contains 240 shots with 9 km offset. The shot spacing is 75 m. A shot is displayed FIG. 3. We then inverted this data set starting with the initial model displayed FIG. 2. I used a frequency-domain implementation (Plessix 2007, 2009), but similar results could be obtained with a time-domain implementation. A shot computed in this initial model is displayed FIG. 4. This initial model is relatively far from the true one. The horizons are not at the correct depth. On FIG. 5, we can notice phase differences around the long offset first breaks. However, the vertical traveltimes (corresponding here to the zero-offset traveltimes) are the same in the two velocity models. We can see, FIG. 5, that the reflected events are in phase between the two data sets, at least at short offsets. Although this initial model is relatively crude, it could have been derived from a crude reflection velocity analysis assuming constant velocity in each layer.

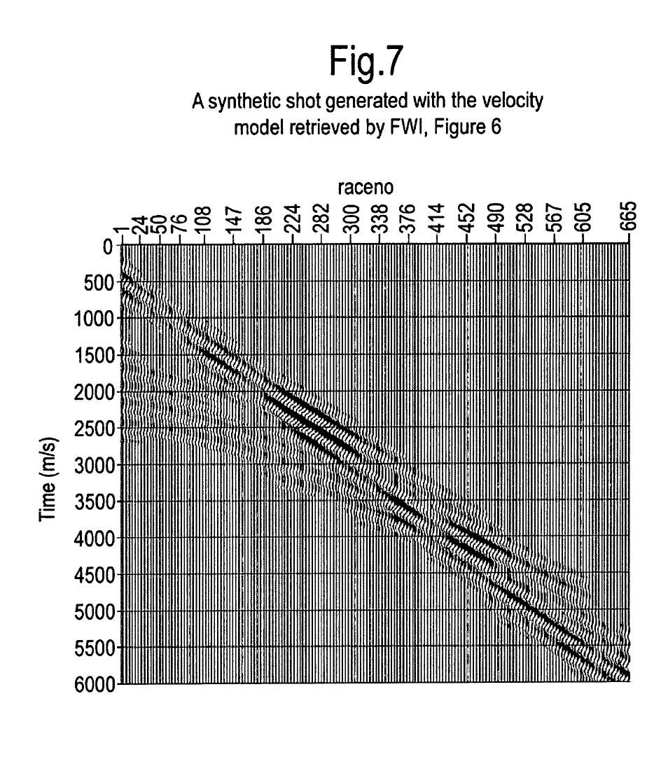

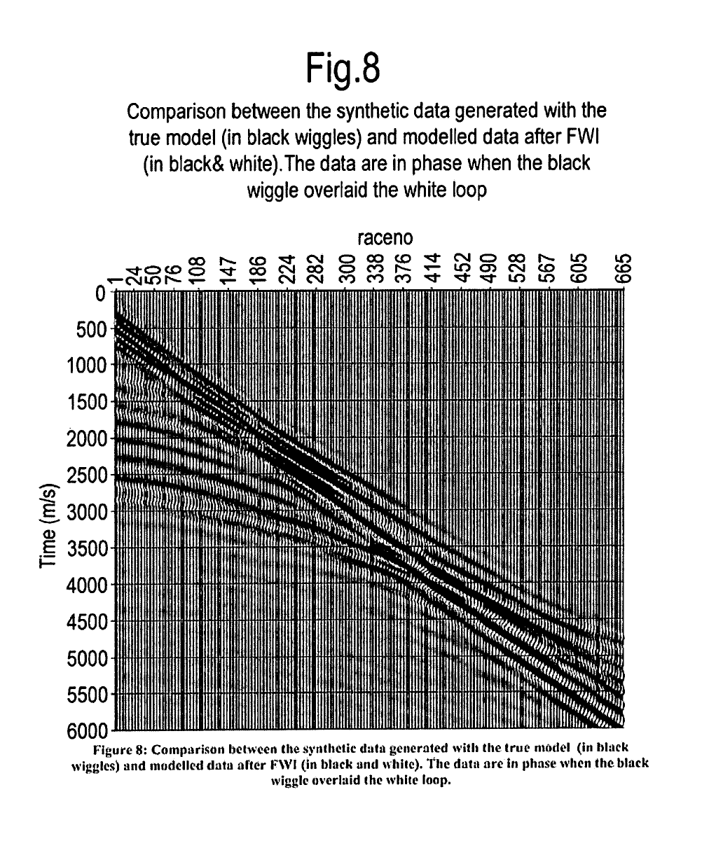

FWI is carried out using a classic multiscale approach. The frequencies 3, 4, 5 and 6.5 Hz are sequentially inverted. The velocity result is displayed FIG. 6 and a shot gather computed with this model, FIG. 7. FWI increased the velocity at 2.7 km depth to try to correctly reposition this interface. However, this was at the expense of the layer at 1.2 km. The difficulty for FWI to correctly reposition large velocity contrasts was already noticed when inverting data sets recorded over salt bodies (Plessix 2009). When we compare a true shot gather with the equivalent modelled shot gather after FWI, FIG. 8, we notice that the reflection events have a large phase difference. The velocity update in the shallow part of the modelled created this phase error. It may then help if we could reformulate FWI in a model space that preserves the vertical traveltimes.

### II) Vertical Transversely Isotropic (VTI) Full Waveform Inversion (FWI) in pseudo-time

In a two-layer isotropic medium, assuming the source and receivers at the same depth, the traveltime curve is given by

$$τ ( h , z ) = 2 \frac{ \sqrt{{z}^{2} + {h}^{2}}}{v} \qquad ( 5 )$$

with h the half offset between the source and the receiver; z the depth of the reflector and v the velocity.

$$\frac{z}{v}$$

is the one-way vertical traveltime. One can easily reparameterize the traveltime curve with

$$\begin{matrix}\tilde{h} = h , ; & ( 6 ) \\ \tilde{z} = \frac{h}{v} and & \\ \tilde{v} = v & \\ τ ( x , z ) = \tilde{τ} ( \tilde{x} , \tilde{z} ) = 2 \sqrt{{\tilde{z}}^{2} + {( \frac{\tilde{h}}{\tilde{v}} )}^{2}} . & \end{matrix}$$

\tilde{z} can be called a pseudo-time or one-way vertical time (Doherty and Clearbout 1976, Alkhalifah et al. 2001). The variables and functions in the pseudo-time coordinate system (\tilde{h},\tilde{z}) are noted with a tilde to distinguish them from the variables and functions in the depth coordinate system (h,z). In this pseudo-time coordinate system, the zero-offset traveltimes do not depend on velocity.

In a VTI medium, the traveltime inversion curves can be parameterized with the vertical traveltime, the nmo velocity and η parameters (Alkhalifah et al. 2001). FWI formulated in a pseudo-time coordinate system will then more naturally preserve the vertical traveltime and may gain the robustness of the classic time processing.

Classic time processing (Yilmaz 2001, Robein 2003) is not adapted to complex geological settings because it assumes mild lateral variations. It is however possible to develop a processing in pseudo-time coordinate system without assuming mild lateral variations (Snieder et al. 1986, Alkhalifah et al. 2001, Alkhalifah 2003). The idea is to apply a change of variables that generalizes the above concept. One then defines the coordinate system transform between the depth coordinate system to the pseudo-time coordinate system by:

$$\{ \begin{matrix}\tilde{x} = x \\ \tilde{y} = y \\ \tilde{z} = {\tilde{z}}_{0} + {\int }_{{z}_{0}}^{z} \frac{1}{{v}_{v} ( x , y , {z}^{′} )} d {z}^{′}\end{matrix} \qquad ( 7 )$$

with z₀ the depth origin and \tilde{z}₀ the pseudo-time origin, and vᵥ the vertical velocity

$${v}_{v} = \frac{{v}_{n}}{\sqrt{1 + 2 δ}} .$$

One can also define the inverse of the coordinate system transform by

$$\{ \begin{matrix}x = \tilde{x} \\ y = \tilde{y} \\ z = {z}_{0} + {\int }_{{\tilde{z}}_{0}}^{\tilde{z}} {\tilde{v}}_{v} ( \tilde{x} , \tilde{y} , {\tilde{z}}^{′} ) d {\tilde{z}}^{′}\end{matrix} \qquad ( 8 )$$

Again, we write with a tilde the functions in the pseudo-time coordinate system.

In appendix A, the first-order wave equation in pseudo-time coordinate system is derived. The dependency on the velocity is rather complicated because the change of variables, system (7), depends on velocity. To understand the relevance of the pseudo-time formulation, we neglect the derivatives of the earth parameters with respect to the pressure derivatives.

We then have:

$$\{ \begin{matrix}{\partial }_{x} \approx {\partial }_{\tilde{x}} \\ {\partial }_{y} \approx {\partial }_{\tilde{y}} \\ {\partial }_{z} \approx \frac{1}{{\tilde{v}}_{v}} {\partial }_{\tilde{z}}\end{matrix} \qquad ( 9 )$$

The approximated constant density second-order wave equations in the pseudo-time coordinate system is

$$\{ \begin{matrix}\frac{1}{{\tilde{v}}_{n}^{2}} {\partial }_{tt} {\tilde{p}}_{n} - ( {\partial }_{\tilde{x} \tilde{x}} {\tilde{p}}_{h} + {\partial }_{\tilde{y} \tilde{y}} {\tilde{p}}_{h} ) - \frac{1}{{\tilde{v}}_{n}^{2}} {\partial }_{\tilde{z} \tilde{z}} {\tilde{p}}_{n} = \tilde{s} \\ \frac{1}{{\tilde{v}}_{n}^{2}} {\partial }_{tt} {\tilde{p}}_{h} - ( 1 + 2 η ) ( {\partial }_{\tilde{x} \tilde{x}} {\tilde{p}}_{h} + {\partial }_{\tilde{y} \tilde{y}} {\tilde{p}}_{h} ) - \frac{1}{{\tilde{v}}_{n}^{2}} {\partial }_{\tilde{z} \tilde{z}} {\tilde{p}}_{n} = \tilde{s}\end{matrix} \qquad ( 10 )$$

Here the quantities depend on \tilde{x}, the coordinate vector in the pseudo-time coordinate system formed with the two lateral coordinates and a vertical time.

We can see that the time, t, and the pseudo-time, \tilde{z}, play a similar role in equation (10). At small offsets, changing \tilde{v}ₙ does not really modify the time behavior of the pressure fields at surface. The one-dimensional wave equation is even independent of the velocity. This has been noticed a long time ago and this idea was, for instance, at the origin of the migration-based traveltime formulation for automatic migration-based velocity analysis and is related to the techniques based on migration/demigration (Symes and Carrazone 1991; Clement and Chavent 1993; Chavent and Jacewitz 1995; Plessix et al. 1999; Chauris and Noble 2001; Symes 2008). The semblance and differential semblance are however formulated in depth coordinate. Like FWI, they will also benefit from a pseudo-time formulation.

Formulating the full waveform inversion in the pseudo-time model space may then help us to preserve the phases of the short offset events. However, we do not want to use equations (10) that are not valid when the earth parameters vary significantly. Using the wave equation in the pseudo-time coordinate system, equation (A.2), leads to a rather complicated implementation. We therefore propose to apply the change of variables at the level of the functional.

Given an earth model, \tilde{m}, parameterized with K elements, \tilde{m}ₖ, in the pseudo-time coordinate system, we first transform this earth model in the depth coordinate system, m(\tilde{m}), parameterized with I elements, mᵢ(\tilde{m}ₖ). We compute the synthetics, c(m), by solving the wave equations (1). This gives the misfit functional J(m)=½∥W(c(m)−d)∥ and we define \tilde{J}(\tilde{m})=J(m). We compute the gradient of the misfit functional with respect to the earth model in the depth coordinate system, ∂ₘ_{ᵢ}J. Finally, we obtain the gradient of the misfit functional with respect to the earth model in the pseudo-time coordinate system by applying the standard chain rules between the two coordinate systems, ∂_{\tilde{m}}ₖ\tilde{J}=Σᵢ(∂_{\tilde{m}}_{ₖ}mᵢ)(∂ₘ_{ᵢ}J). More details are given in Appendix B. Snieder et al, 1989, already proposed a full waveform inversion that was partially parameterized in the pseudo-time coordinate system. However, in their approach only the reflectivity is parameterized in the pseudo-time coordinate system. The non-linear inversion is still carried out with a model parameterized in the depth coordinate system (see Appendix C).

### III) Example 1

To evaluate whether this approach is valid with large lateral variations, seismograms with different laterally-varying velocity models were computed and compared.

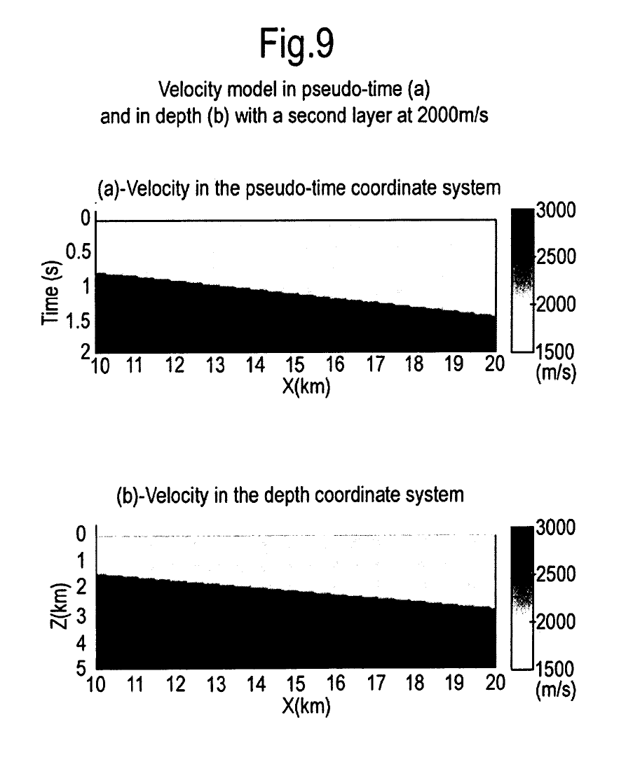

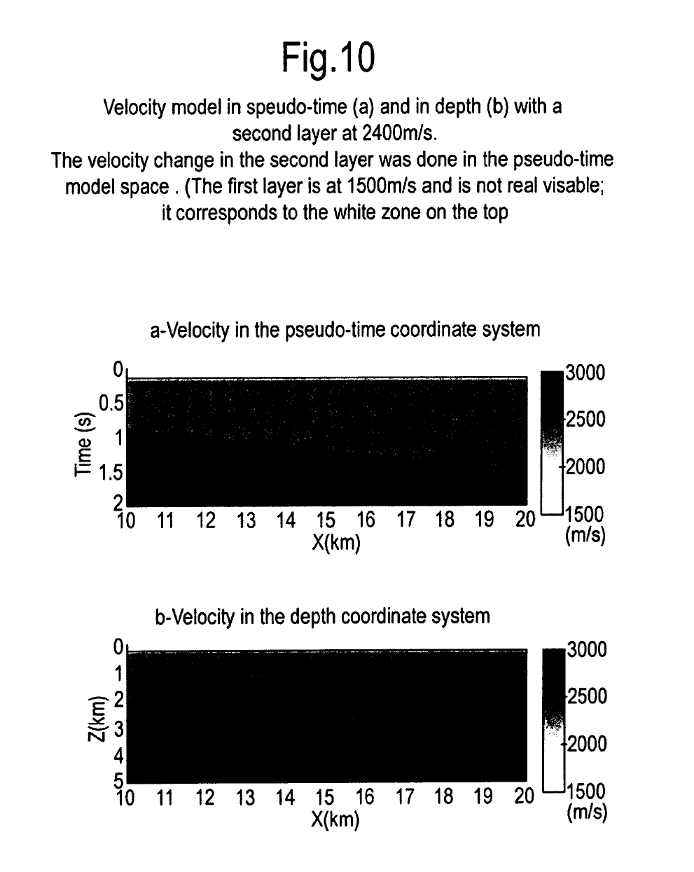

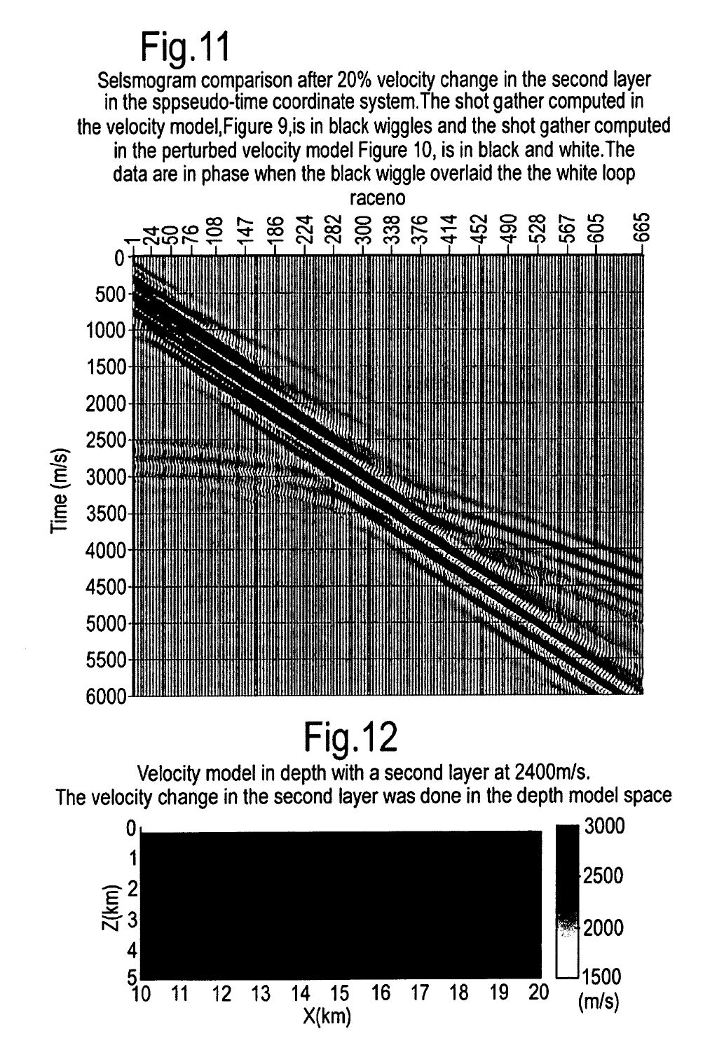

We first considered the velocity model in the pseudo-time coordinate system, FIG. 9.a, transformed it in the depth coordinate system, FIG. 9.b, and computed a reference shot gather.

Secondly, we perturbed by 20% the second layer of the velocity model FIG. 9.a, from 2000 m/s to 2400 m/s. Here, the perturbation is done in the pseudo-time model space. The velocity is displayed FIG. 10.a and FIG. 10.b after transformation in the depth coordinate system. The shot gather computed in this perturbed velocity model is plotted in black and white in the background of FIG. 11 while the reference shot gather is plotted in black wiggles. The two reflected events at about 2.8 s are in phase at short offsets, although the velocity difference in the second layer is 400 m/s. The reflected events approximately stay at the same vertical time because in depth not only the velocity of the layer changes, but also the depth location of the interface.

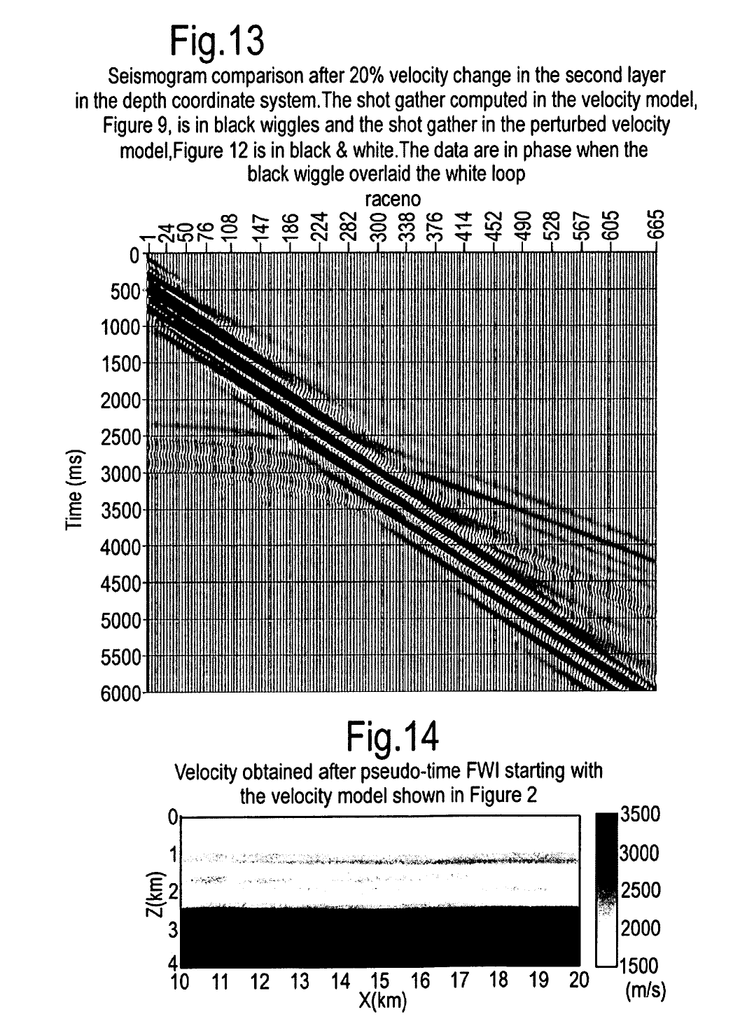

Thirdly, we perturbed by 20% the second layer of the velocity model FIG. 9.b. Now, the perturbation is done in the depth model space. The velocity is displayed FIG. 12. The shot gather computed in this perturbed model is displayed in the background of FIG. 13 while the reference shot gather is plotted in black wiggles. We clearly see a large time (phase) difference at the reflection event at 2.8 s.

This modelling exercise shows that a 20% velocity change in the second layer of the velocity model in the pseudo-time model space does not create a loop-skipping at the short offsets between the reflected event, while the same change in the depth model space creates a large loop skipping. This seems to confirm that FWI will be better posed in the pseudo-time model space than in the depth model space, especially when the initial model is obtained after velocity analysis based on reflection data. This, however, does not mean that FWI does not have local minima in the pseudo-time model space. In fact, with this quite large velocity change, we do notice some loop skipping between the two seismograms in FIG. 11, especially at long offsets.

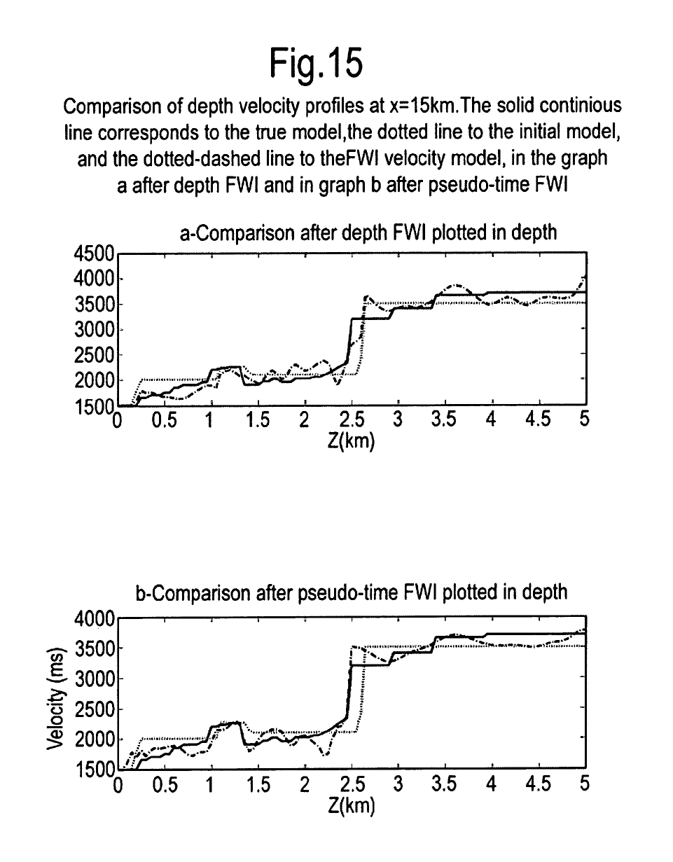

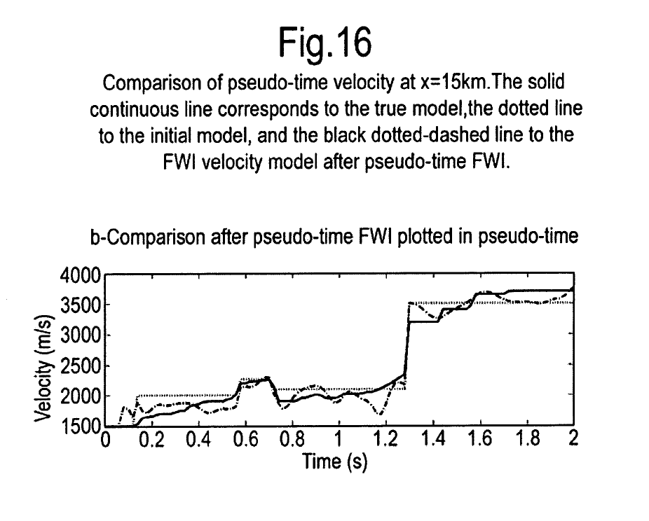

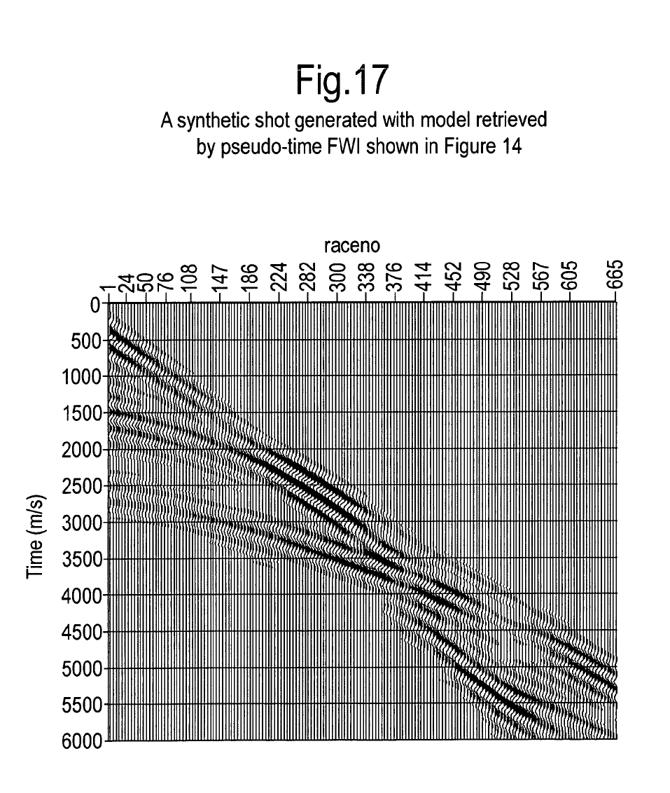

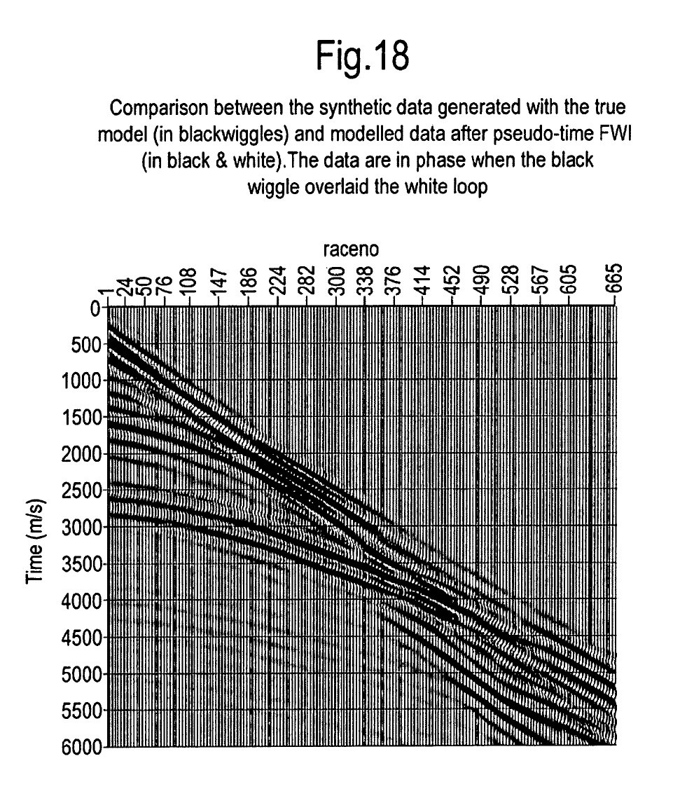

We then invert the synthetic data set, FIG. 4, generated with the velocity model, FIG. 1, with the pseudo-time FWI formulation. we still used a frequency-domain implementation. The initial model is the equivalent of the velocity model, FIG. 2, but in the pseudo-time coordinate system. As previously, a multiscale approach is used: the frequencies 3, 4, 5, and 6.5 Hz are inverted sequentially. The FWI velocity result is displayed FIG. 14 after having applied the coordinate change between pseudo-time and depth. We see that the interface at about 2.7 km depth has been lifted up in depth, together with the layer at about 1.2 km depth. The structure of the layer at 1.2 km has not been damaged during the inversion. In FIG. 15, velocity depth profiles are displayed to compare the behaviour of the depth and pseudo-time FWI. The pseudo-time formulation moves the velocity discontinuities in depth and seems to better retain the layer discontinuities than the depth formulation. In fact, the discontinuities are more or less unchanged in the vertical axis of FWI as already noted. With the pseudo-time FWI, the discontinuities are more or less unchanged in pseudo-time, FIG. 16, but move in depth to preserve the vertical traveltimes. In FIG. 17, a shot gather computed in the pseudo-time FWI velocity is displayed and in FIG. 18, the reference shot is superimposed over this shot gather. We can see that the reflected events are still in phase after pseudo-time FWI.

If a discontinuity is better known in pseudo-time than in depth, the pseudo-time FWI formulation is the preferred approach. This is the case when we have only reflection data (see Appendix C).

### IV) Example 2

Example 2 provides a simple full waveform inversion synthetic example.

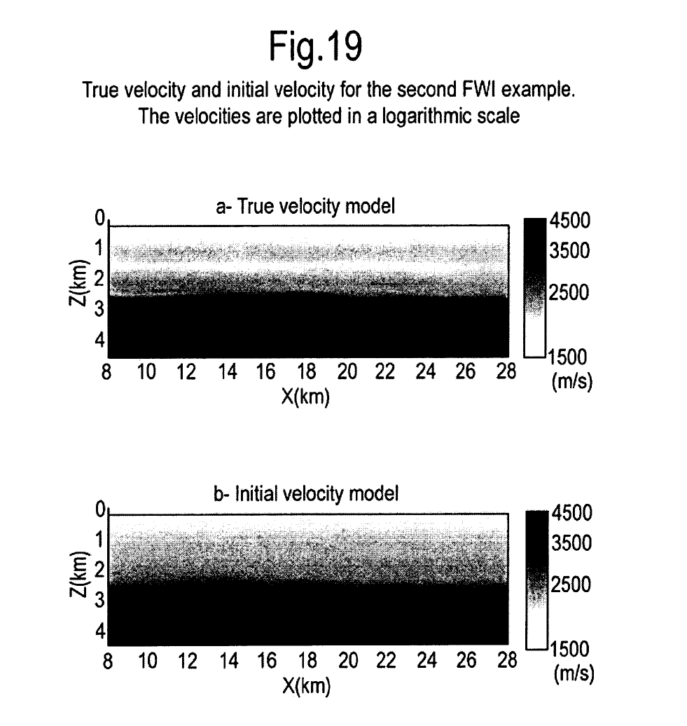

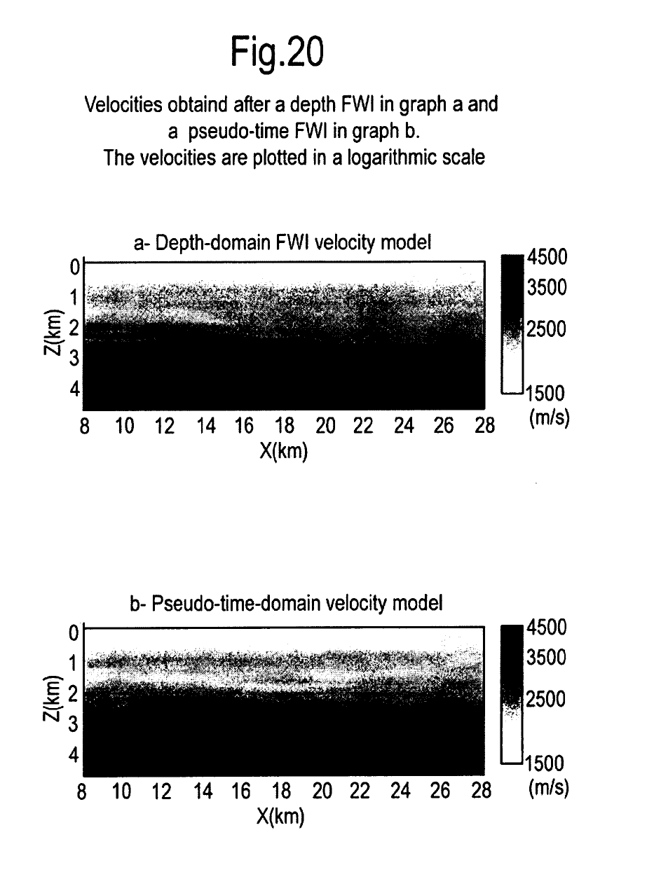

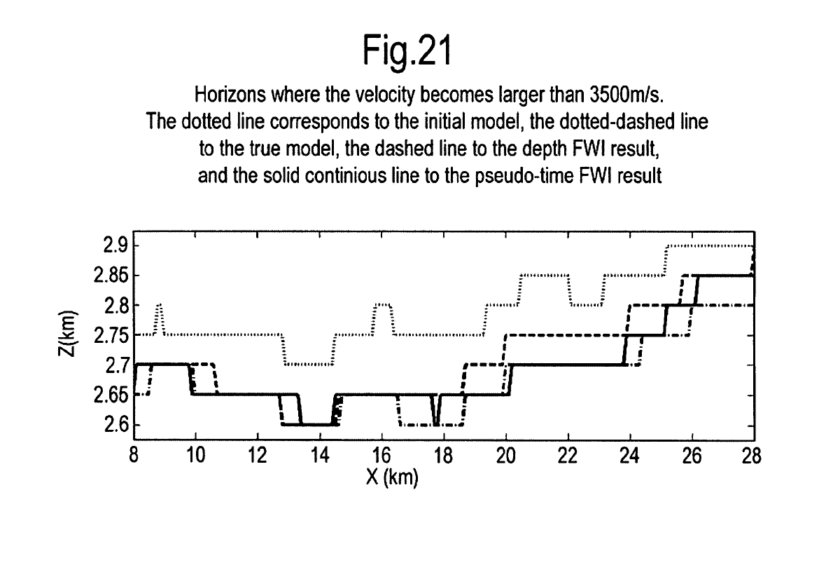

In Example 1 strong discontinuities were present in the initial model. Since we work at low frequencies, we may smooth these discontinuities before starting FWI. Here, we then present a simple FWI where the interfaces have been smoothed. The true velocity is displayed FIG. 19.a. The data are generated using the same acquisition geometry that in the first example. The initial velocity model is plotted FIG. 19.b. Using a multiscale approach, the frequencies 3, 4, 5, and 6.5 Hz are inverted. The FWI results are shown FIG. 20. Depth and pseudo-time FWI give similar results. The velocity inversion is however slightly better recovered with the pseudo-time formulation; see FIG. 22. To further evaluate the results, we picked the depths where the velocity becomes larger than 3500 m/s. This more or less corresponds to the horizon at about 2.7 km depth. The picked horizons in the four velocity models are displayed FIG. 21. Velocity depth profiles are also plotted in FIG. 22. Both FWI approaches fairly recover this horizon, since 50 m corresponds to the depth discretization. The pseudo-time FWI approach leads to a more accurate result.

### V) Conclusions

A pseudo-time formulation of full waveform inversion has been proposed to improve the robustness of the method. This is especially relevant when the initial model is constructed by reflection travel time inversion and contains structural information such as interfaces. This new formulation consists of representing the earth model parameters in a pseudo-time coordinate system. In this system, the vertical axis is vertical time instead of depth. The pseudo-time approach, as in classic time domain velocity analysis, reduces the velocity/depth ambiguity of the depth formulation of full waveform inversion. Indeed, the time location of the discontinuities at small offsets is preserved during inversion. This reduces the chances of ending up in a local minimum because the synthetics and the observed data stay in phase at short offsets, assuming they were in phase at the start of the inversion.

This proposed pseudo-time full waveform inversion does not rely on a mild lateral variation assumption. This is achieved through a change of variables between the depth coordinate system and the pseudo-time coordinate system. This change of variations depends on the vertical velocity. Although the change of variables on the wave equation can be directly applied to the wave equation, this leads to a rather complicated implementation.

A simpler approach consists of applying the change of variables at the level of the misfit functional. The wave equation is then solved in the depth coordinate system and the gradient in the pseudo-time coordinate system is obtained from the gradient in the depth coordinate system with the standard chain rules.

The relevance of the new pseudo-time formulation in the FWI method according to the invention has been illustrated on the basis of two synthetic EXAMPLES 1 and 2, which show that the pseudo-time FWI formulation according to the invention suffers from fewer artefacts than the known depth FWI formulation, especially when the recorded wavefield mainly contains reflection data. Appendices A-D hereinbelow describe several equations that may be applied in the improved FWI method according to the invention.

### Appendix A

Appendix A describes possible wave equations used in the FWI method according to the invention, wherein Appendix A1 describes a first-order VTI wave-equation in depth and Appendix A2 describes a first-order wave equation in pseudo-time.

### Appendix A1

Appendix A1 describes a first-order VTI wave-equation in depth.

By zeroing the shear modulus and using the Thomsen's parameters ε and δ, the first-order VTI wave equations can be written as follows (Duveneck et a. 2008):

$$\{ \begin{matrix}ρ {\partial }_{t} {v}_{x} = - {\partial }_{x} {p}_{h} \\ ρ {\partial }_{t} {v}_{y} = - {\partial }_{y} {p}_{h} \\ ρ {\partial }_{t} {v}_{z} = - {\partial }_{z} {p}_{v} \\ \frac{1}{ρ {v}_{v}^{2}} {\partial }_{t} {p}_{h} = - ( 1 + 2 ɛ ) ( {\partial }_{x} {v}_{x} + {\partial }_{y} {v}_{y} ) - \sqrt{1 + 2 δ} {\partial }_{z} {v}_{z} \\ \frac{1}{ρ {v}_{v}^{2}} {\partial }_{t} {p}_{v} = - \sqrt{1 + 2 δ} ( {\partial }_{x} {v}_{x} + {\partial }_{y} {v}_{y} ) - {\partial }_{z} {v}_{z}\end{matrix} \qquad ( A .1 )$$

Here vᵥ is the vertical velocity; ε and δ the Thomsen's parameters, ρ the density; vₓ, v_{y}, and v_{z} the particle velocities; pₕ and pᵥ the opposites of the horizontal and vertical stresses, that we called horizontal and vertical pressures.

We now rewrite these equations with pₙ=\sqrt{1+2δ} pᵥ, the NMO pressure,

$$η = \frac{ɛ - δ}{1 + 2 δ}$$

### and δ (Plessix and Rynja 2010)

$$\begin{matrix}\{ \begin{matrix}ρ {\partial }_{t} {v}_{x} = - {\partial }_{x} {p}_{h} \\ ρ {\partial }_{t} {v}_{y} = - {\partial }_{y} {p}_{h} \\ ρ {\partial }_{t} {v}_{z} = - {\partial }_{z} \frac{{p}_{n}}{\sqrt{1 + 2 δ}} \\ \frac{1}{ρ {v}_{n}^{2}} {\partial }_{t} {p}_{h} = - ( 1 + 2 η ) ( {\partial }_{x} {v}_{x} + {\partial }_{y} {v}_{y} ) - \frac{1}{\sqrt{1 + 2 δ}} {\partial }_{z} {v}_{z} \\ \frac{1}{ρ {v}_{n}^{2}} {\partial }_{t} {p}_{n} = - ( {\partial }_{x} {v}_{x} + {\partial }_{y} {v}_{y} ) - \frac{1}{\sqrt{1 + 2 δ}} {\partial }_{z} {v}_{z}\end{matrix} & ( A .2 )\end{matrix}$$

### Appendix A2

Appendix A2 describes how a first-order wave equation in pseudo-time may be obtained in the FWI method according to the invention.

With the change of variables, system (7), we have

$$\begin{matrix}\{ \begin{matrix}{\partial }_{x} = {\partial }_{\tilde{x}} + {\tilde{s}}_{x} {\partial }_{\tilde{z}} \\ {\partial }_{y} = {\partial }_{\tilde{y}} + {\tilde{s}}_{y} {\partial }_{\tilde{z}} \\ {\partial }_{z} = \frac{1}{{\tilde{v}}_{v}} {\partial }_{\tilde{z}}\end{matrix} \\ with & ( A .3 ) \\ \{ \begin{matrix}{\tilde{s}}_{x} = {\int }_{{z}_{0}}^{z} {\partial }_{x} ( \frac{1}{{v}_{v} ( x , y , {z}^{′} )} ) d {z}^{′} \\ {\tilde{s}}_{y} = {\int }_{{z}_{0}}^{z} {\partial }_{y} ( \frac{1}{{v}_{v} ( x , y , {z}^{′} )} ) d {z}^{′}\end{matrix} & ( A .4 )\end{matrix}$$

the wave equation in pseudo-time then reads:

$$\begin{matrix}\{ \begin{matrix}\tilde{ρ} {\partial }_{t} {\tilde{v}}_{x} = - {\partial }_{\tilde{x}} {\tilde{p}}_{h} - {\tilde{s}}_{x} {\partial }_{\tilde{z}} {\tilde{p}}_{h} \\ \tilde{ρ} {\partial }_{t} {\tilde{v}}_{y} = - {\partial }_{\tilde{y}} {\tilde{p}}_{h} - {\tilde{s}}_{y} {\partial }_{\tilde{z}} {\tilde{p}}_{h} \\ \tilde{ρ} {\partial }_{t} {\tilde{v}}_{z} = - \frac{\sqrt{1 + 2 \tilde{δ}}}{{\tilde{v}}_{n}} {\partial }_{z} \frac{{\tilde{p}}_{n}}{\sqrt{1 + 2 \tilde{δ}}} \\ \frac{1}{\tilde{ρ} {\tilde{v}}_{n}^{2} } {\partial }_{t} {\tilde{p}}_{h} = - ( 1 + 2 \tilde{η} ) ( {\partial }_{\tilde{x}} {\tilde{v}}_{x} + {\partial }_{\tilde{y}} {\tilde{v}}_{y} + {\tilde{s}}_{x} {\partial }_{\tilde{z}} {\tilde{v}}_{x} + {\tilde{s}}_{y} {\partial }_{\tilde{z}} {\tilde{v}}_{y} ) - \frac{1}{{\tilde{v}}_{n}} {\partial }_{z} {v}_{z} \\ \frac{1}{\tilde{ρ} {\tilde{v}}_{n}^{2} } {\partial }_{t} {\tilde{p}}_{n} = - ( {\partial }_{\tilde{x}} {\tilde{v}}_{x} + {\partial }_{\tilde{y}} {\tilde{v}}_{y} + {\tilde{s}}_{x} {\partial }_{\tilde{z}} {\tilde{v}}_{x} + {\tilde{s}}_{y} {\partial }_{\tilde{z}} {\tilde{v}}_{y} ) - \frac{1}{{\tilde{v}}_{n}} {\partial }_{z} {v}_{z}\end{matrix} & ( A .5 )\end{matrix}$$

The functions with tilde depend on (\tilde{x},\tilde{y},\tilde{z}). The dependency on \tilde{v}ₙ is complicated since \tilde{s}ₓ and \tilde{s}_{y} implicitly depend on \tilde{v}ₙ.

This derivation is similar to the one made in Alkhalifah, 2001.

### Appendix B

Appendix B describes how the gradient of the pseudo-time Full Waveform Inversion (FWI) misfit functional may be obtained.
In the pseudo-time model space, the earth parameters are (\tilde{v}ₙ,\tilde{η},\tilde{δ}). We have

$${\tilde{v}}_{v} = \frac{{\tilde{v}}_{n}}{\sqrt{1 + 2 \tilde{δ}}} .$$

Let us for the moment assume that \tilde{v}ᵥ is an independent parameter, and define the misfit functional \tilde{J}₁ by

\tilde{J}₁(\tilde{v}ₙ,\tilde{η},\tilde{δ},\tilde{v}ᵥ)=J(\tilde{v}ₙ[\tilde{v}ₙ,\tilde{v}ᵥ],η[\tilde{η},\tilde{v}ᵥ],δ[\tilde{δ},\tilde{v}ᵥ]) (B.1)

(the density is not included to simplify the notation, but it is not a problem to add it).
The depth model parameters are obtained by

$$\{ \begin{matrix}{v}_{n} [ {\tilde{v}}_{n} , {\tilde{v}}_{v} ] ( x , y , z ) = {\tilde{v}}_{n} ( \tilde{x} , \tilde{y} , \tilde{z} ) \\ η [ \tilde{η} , {\tilde{v}}_{v} ] ( x , y , z ) = \tilde{η} ( \tilde{x} , \tilde{y} , \tilde{z} ) \\ δ [ \tilde{δ} , {\tilde{v}}_{v} ] ( x , y , z ) = \tilde{δ} ( \tilde{x} , \tilde{y} , \tilde{z} )\end{matrix} \qquad ( B .2 )$$

with (\tilde{x},\tilde{y},\tilde{z}) obtained such that

$$\{ \begin{matrix}x = \tilde{x} \\ y = \tilde{y} \\ z = {\int }_{0}^{\tilde{z}} {\tilde{v}}_{v} ( \tilde{x} , \tilde{y} , {\tilde{z}}^{′} ) d {\tilde{z}}^{′}\end{matrix} \qquad ( B .3 )$$

(One assumes the origins z₀ and \tilde{z}₀ equal to 0 to simplify the notation.)
The parameters vₙ, η, and δ depend on \tilde{v}ᵥ because \tilde{z} depends on \tilde{v}ᵥ.

### Assuming

$$\frac{\partial J}{\partial {v}_{n}} , \frac{\partial J}{\partial η} , and \frac{\partial J}{\partial δ}$$

computed, the derivatives of \tilde{J}₁ are given by (the dependency on (x,y) or (\tilde{x},\tilde{y}) are not written)

$$\{ \begin{matrix}\frac{\partial {\tilde{J}}_{1}}{\partial {\tilde{v}}_{n} ( {\tilde{z}}_{c} )} = {\int }_{0}^{{z}_{max}} \frac{\partial J}{\partial {v}_{n} ( z )} \frac{\partial {v}_{n} ( z )}{\partial {\tilde{v}}_{n} ( {\tilde{z}}_{c} )} d z \\ \frac{\partial {\tilde{J}}_{1}}{\partial \tilde{η} ( {\tilde{z}}_{c} )} = {\int }_{0}^{{z}_{max}} \frac{\partial J}{\partial η ( z )} \frac{\partial η ( z )}{\partial \tilde{η} ( {\tilde{z}}_{c} )} d z \\ \frac{\partial {\tilde{J}}_{1}}{\partial \tilde{δ} ( {\tilde{z}}_{c} )} = {\int }_{0}^{{z}_{max}} \frac{\partial J}{\partial δ ( z )} \frac{\partial δ ( z )}{\partial \tilde{δ} ( {\tilde{z}}_{c} )} d z \\ \frac{\partial {\tilde{J}}_{1}}{\partial {\tilde{v}}_{v} ( {\tilde{z}}_{c} )} = \begin{matrix}{\int }_{0}^{{z}_{max}} \frac{\partial J}{\partial {v}_{n} ( z )} \frac{\partial {v}_{n} ( z )}{\partial {\tilde{v}}_{v} ( {\tilde{z}}_{c} )} d z + \\ {\int }_{0}^{{z}_{max}} \frac{\partial J}{\partial η ( z )} \frac{\partial η ( z )}{\partial {\tilde{v}}_{v} ( {\tilde{z}}_{c} )} d z + \\ {\int }_{0}^{{z}_{max}} \frac{\partial J}{\partial δ ( z )} \frac{\partial δ ( z )}{\partial {\tilde{v}}_{v} ( {\tilde{z}}_{c} )} d z\end{matrix}\end{matrix} \qquad ( B .4 )$$

Here, zₘₐₓ is the maximum depth of the model and \tilde{z}_{c} is a subsurface pseudo-time point.
We have, with δ_{d} the Dirac distribution,

$$\{ \begin{matrix}\frac{\partial {v}_{n} ( z )}{\partial {\tilde{v}}_{n} ( {\tilde{z}}_{c} )} = {δ}_{d} ( {z}_{c} - z ) \frac{\partial {v}_{n} ( z )}{\partial {\tilde{v}}_{n} ( {\tilde{z}}_{c} )} \\ \frac{\partial η ( z )}{\partial \tilde{η} ( {\tilde{z}}_{c} )} = {δ}_{d} ( {z}_{c} - z ) \frac{\partial η ( z )}{\partial \tilde{η} ( {\tilde{z}}_{c} )} \\ \frac{\partial δ ( z )}{\partial \tilde{δ} ( {\tilde{z}}_{c} )} = {δ}_{d} ( {z}_{c} - z ) \frac{\partial δ ( z )}{\partial \tilde{δ} ( {\tilde{z}}_{c} )}\end{matrix} \\ with \\ {z}_{c} = {\int }_{0}^{{\tilde{z}}_{c}} {\tilde{v}}_{v} ( \tilde{z} ) d \tilde{z}$$

### Therefore

$$\{ \begin{matrix}\frac{\partial {\tilde{J}}_{1}}{\partial {\tilde{v}}_{n} ( {\tilde{z}}_{c} )} = \frac{\partial J}{\partial {v}_{n} ( z )} \\ \frac{\partial {\tilde{J}}_{1}}{\partial \tilde{η} ( {\tilde{z}}_{c} )} = \frac{\partial J}{\partial η ( z )} \\ \frac{\partial {\tilde{J}}_{1}}{\partial \tilde{δ} ( {\tilde{z}}_{c} )} = \frac{\partial J}{\partial δ ( z )}\end{matrix} \qquad ( B .5 )$$

At a subsurface depth point, zₚ, vₙ(zₚ)=\tilde{v}ₙ(\tilde{z}ₚ) with \tilde{z}ₚ depending on \tilde{v}ᵥ through zₚ=∫₀^{\tilde{z}}^{ₚ}\tilde{v}ᵥ(\tilde{z})d\tilde{z}, we have

$$\frac{\partial {v}_{n} ( {z}_{p} )}{\partial {\tilde{v}}_{v} ( {\tilde{z}}_{c} )} = \frac{\partial {\tilde{v}}_{n} ( {\tilde{z}}_{p} )}{\partial \tilde{z}} \frac{\partial {\tilde{z}}_{p}}{\partial {\tilde{v}}_{v} ( {\tilde{z}}_{c} )}$$

Because zₚ is fixed, if \tilde{z}_{c}<\tilde{z}ₚ, we have

$$\begin{matrix}{\int }_{0}^{{\tilde{z}}_{p}} \frac{\partial {\tilde{v}}_{v} ( \tilde{z} )}{\partial {{\tilde{v}}^{ }}_{v} \tilde{( {z}_{c}} )} d \tilde{z} + \frac{\partial {\tilde{z}}_{p}}{\partial {\tilde{v}}_{v} ( {\tilde{z}}_{c} )} {\tilde{v}}_{v} ( {\tilde{z}}_{p} ) = 0 \\ and \\ \frac{\partial {\tilde{v}}_{v} ( \tilde{z} )}{\partial {\tilde{v}}_{v} ( {\tilde{z}}_{c} )} = {δ}_{d} ( \tilde{z} - {\tilde{z}}_{c} )\end{matrix}$$

Therefore if \tilde{z}_{c}<\tilde{z}ₚ

$$\frac{\partial {\tilde{z}}_{p}}{\partial {\tilde{v}}_{v} \tilde{( {z}_{c}} )} = \frac{1}{{\tilde{v}}_{v} ( {\tilde{z}}_{p} )} \cdot$$

### Otherwise

$$\frac{\partial {\tilde{z}}_{p}}{\partial {{\tilde{v}}_{v} ( \tilde{z} )}_{c}} = 0$$

We finally obtain

$$\frac{\partial \tilde{{J}_{1}}}{\partial {\tilde{v}}_{v} \tilde{( {z}_{c}} )} = - {\int }_{{Z}_{c}}^{Zmax} \frac{1}{{v}_{v} ( z )} ( \frac{\partial {v}_{n} ( z )}{\partial z} \frac{\partial J}{\partial {v}_{n} ( z )} + \frac{\partial η ( z )}{\partial z} \frac{\partial J}{\partial η ( z )} + \frac{\partial δ ( z )}{\partial z} \frac{\partial J}{\partial δ ( z )} ) d z \qquad ( B .6 )$$

We now have to take into account that \tilde{v}ᵥ depends on \tilde{v}ₙ and δ. The pseudo-time FWI misfit functional, \tilde{J} is defined by

$$\tilde{J} ( {\tilde{v}}_{n} , \tilde{η} , \tilde{δ} ) = {\tilde{J}}_{1} ( {\tilde{v}}_{n} , \tilde{η} , \tilde{δ} , \frac{{\tilde{v}}_{n}}{\sqrt{1 + 2 \tilde{δ}}} ) \qquad ( B .7 )$$

And the derivatives are given by

$$\{ \begin{matrix}\frac{\partial \tilde{J}}{\partial {\tilde{v}}_{n}} = \frac{\partial \tilde{J}}{\partial {\tilde{v}}_{n}} + \frac{1}{\sqrt{1 + 2 \tilde{δ}}} \frac{\partial {\tilde{J}}_{1}}{\partial {\tilde{v}}_{v}} \\ \frac{\partial \tilde{J}}{\partial \tilde{η}} = \frac{\partial \tilde{{J}_{1}}}{\partial \tilde{η}} \\ \frac{\partial \tilde{J}}{\partial \tilde{δ}} = \frac{\partial \tilde{{J}_{1}}}{\partial \tilde{δ}} + \frac{{\tilde{v}}_{n}}{{( 1 + 2 \tilde{δ} )}^{3 / 2}} \frac{\partial \tilde{{J}_{1}}}{\partial {\tilde{v}}_{v}}\end{matrix} \qquad ( B .8 )$$

### Appendix C

Appendix C describes how full waveform inversion and linearization may be achieved.

With reflection data, migration velocity analysis techniques (Symes 2008) are generally based on a linearization of the wave equation. With L the wave operator, one can write the linearized (Born) wave equations as follows

$$\{ \begin{matrix}L ( {m}^{0} ) {p}^{0} = s \\ L ( {m}^{0} ) {p}^{1} = - \frac{\partial L}{\partial m} {p}^{0} δ m\end{matrix} \\ with \\ \{ \begin{matrix}m = {m}^{0} + δ m \\ p \approx {p}^{0} + {p}^{1} .\end{matrix} \qquad ( C .1 )$$

Here, m⁰ represents the propagation model, it is often called background and corresponds to the low spatial wavelengths of the earth model; and δm represents the reflectivity or impedance and corresponds to the high spatial wavelengths of the earth model. p⁰ is the incident field and p¹ the scattered field. In this context, the full waveform inversion reads

J(m⁰,δm)= 1/2∥W(c−d)∥

with c=S(p⁰+p¹).

The inversion depends on the propagation model and the reflectivity model that can be treated as independent variables. The synthetics, c, linearly depend on the reflectivity; therefore for a fixed propagation model, the misfit is quadratic in δm. The reflectivity can be retrieved relatively easily by a (least-square) migration (Lailly 1983, Tarantola 1984).

Snieder et al., 1989, proposed to alternatively retrieve the reflectivity and the propagation. To better decouple these two variables, they parameterized the propagation in the depth coordinate system but the impedance in the pseudo-time coordinate system. In this way, the vertical time of the events in the impedance is almost independent of the propagation, which avoids some of the non-linearity in the misfit functional.

Examples of this approach can also be found in Pratt et al., 1998.

The non-linear minimization to retrieve m⁰ is carried out with the propagation model parameterized in the depth coordinate system.

If we define the reduced misfit functional

$${J}^{r} ( {m}^{0} ) = J ( {m}^{0} , δ {m}^{*} ( {m}^{0} ) ) \\ with \\ δ {m}^{*} ( {m}^{0} ) = {Arg min}_{δ m} ( J ( {m}^{0} , δ m ) ) , \qquad ( C .2 )$$

we obtain the migration based travel time method (Clement and Chavent 1993, Plessix et al. 1999). The synthetics are computed after migration and demigration. Therefore the zero-offset times of the reflected events are independent of the propagation reducing the non-linearity of the misfit functional. The dependency on the propagation model comes from the NMO curvature of the reflected events. The propagation model is parameterized in the depth coordinate system.

From the foregoing it will be understood that the method according to the present invention differs from known approaches because the propagation model is parameterized in the pseudo-time coordinate system. Optionally, the method according to the present invention may furthermore differ from the known approaches if the gradient of the misfit function is obtained as described in Appendix B.

1. A method of estimating an earth model through an acoustic full waveform inversion of seismic data in a pseudo-time coordinate system, in which an earth model is parameterized with two lateral coordinates and a vertical coordinate which expresses vertical travel time of acoustic signals used to generate the seismic data.

2. The method of claim 1, wherein the seismic data are surface seismic data.

3. The method of claim 1, wherein the horizontal coordinates are expressed by the abbreviations x and y and the vertical coordinate which expresses the vertical travel time is expressed by the abbreviation \tilde{z} and is defined at each lateral position (x,y) by
$$\tilde{z} = {\int }_{{z}_{0}}^{z} \frac{d z}{{v}_{v} ( x , y , z )} ,$$
wherein:
vᵥ is a vertical velocity of the acoustic signals,
z is depth, and
z₀ is a depth origin.

4. The method of claim 3, wherein the earth model is expressed by the abbreviation m and comprises a range of variables, such as nmo velocity, reflectivity, η, δ, εVTI parameters, density, vertical and/or velocity, which variables are calculated by an iterative calculation.

5. The method of claim 4, wherein the iterative calculation comprises:
a) generating an initial earth model \tilde{m} in the pseudo-time coordinate system;
b) iteratively looping over a series of scales provided by frequency bands of the seismic data;
c) looping over the iterative loops to obtain an adjusted earth model, \tilde{m} with modelled data;
d) computing the modelled data;
e) evaluating a misfit functional between the modelled and observed data;
f) computing a gradient of the misfit functional with respect to the earth model \tilde{m}; and
g) updating the earth model \tilde{m} with a local optimization technique.

6. The method of claim 5, wherein steps c), d) and f) of the iterative calculation further comprise:
c2) applying a change of variables between the pseudo-time coordinate system to a depth coordinate system to obtain an adjusted earth model, m(\tilde{m}), in depth, with modelled data;
d2) computing the modelled data by solving an acoustic vertical transversely isotropic wave equation in depth;
f2) computing the gradient of the misfit functional with respect to the earth model \tilde{m} by solving adjoint equations of the depth wave equation and correlating incident wave fields and adjoint wave fields; and
applying a change of variables between the depth coordinate system to the pseudo-time coordinate system to obtain a gradient in the pseudo-time coordinate system; and the method further comprises:
g) using the gradient to update the earth model m in the pseudo-time coordinate system with a local optimization technique.

7. The method of claim 6, wherein step d) comprises applying the following set of equations (A.1):
$$\{ \begin{matrix}ρ {\partial }_{t} {v}_{x} = - {\partial }_{x} {p}_{h} \\ ρ {\partial }_{t} {v}_{y} = - {\partial }_{x} {p}_{h} \\ ρ {\partial }_{t} {v}_{z} = - {\partial }_{x} {p}_{h} \\ \frac{1}{ρ {v}_{v}^{2}} {\partial }_{t} {p}_{h} = - ( 1 + 2 ɛ ) ( {\partial }_{x} {v}_{x} + {\partial }_{y} {v}_{y} ) - \sqrt{1 + 2 δ {\partial }_{z }} {v}_{z} \\ \frac{1}{ρ {v}_{v}^{2}} {\partial }_{t} {p}_{h} = - \sqrt{1 + 2 δ} ( {\partial }_{x} {v}_{x} + {\partial }_{y} {v}_{y} ) - {\partial }_{z} {v}_{z} \\ \end{matrix} \qquad ( A .1 )$$
wherein:
vᵥ is the vertical velocity;
ε and δ are known as Thomsen's parameters,
ρ is the density;
vₓ, v_{y}, and v_{z} are the particle velocities;
pₕ and pᵥ are the opposites of the horizontal and vertical stresses, which are also referred to as horizontal and vertical pressures.

8. The method of claim 7, wherein the set of equations (A.1) is rewritten with pₙ=\sqrt{1+2δ} pᵥ, the NMO pressure,
$$η = \frac{ɛ - δ}{1 + 2 δ}$$
and δ as the following set of equations (A.2):
$$\{ \begin{matrix}ρ {\partial }_{t} {v}_{x} = - {\partial }_{x} {p}_{h} \\ ρ {\partial }_{t} {v}_{y} = - {\partial }_{x} {p}_{h} \\ ρ {\partial }_{t} {v}_{z} = - {\partial }_{x} {p}_{v} \\ \frac{1}{ρ {v}_{n}^{2}} {\partial }_{t} {p}_{h} = - ( 1 + 2 η ) ( {\partial }_{x} {v}_{x} + {\partial }_{y} {v}_{y} ) - \frac{1}{\sqrt{1 + 2 δ}} {\partial }_{z} {v}_{z} \\ \frac{1}{ρ {v}_{n}^{2}} {\partial }_{t} {p}_{v} = - \sqrt{1 + 2 δ} ( {\partial }_{x} {v}_{x} + {\partial }_{y} {v}_{y} ) - {\partial }_{z} {v}_{z} \\ \end{matrix} \qquad ( A .2 )$$

9. The method of claim 5, wherein steps c) and f) of the iterative calculation further comprise:
c3) computing the modelled data by solving a pseudo-time wave equation; and
f3) computing the gradient of the misfit functional with respect to the earth model by solving the adjoint equation of the pseudo-time wave equation and correlating the incident and adjoint wave fields.

10. The method of claim 8, wherein step c3) further comprises solving the following pseudo-time wave equation (A.5):
$$( A .5 )$$
$$\{ \begin{matrix}\tilde{ρ} {\partial }_{t} {\tilde{v}}_{x} = - {\partial }_{\tilde{x}} {\tilde{p}}_{h} - {\tilde{s}}_{x} {\partial }_{\tilde{z}} {\tilde{p}}_{h} \\ \tilde{ρ} {\partial }_{t} {\tilde{v}}_{y} = - {\partial }_{y} {\tilde{p}}_{h} - {\tilde{s}}_{y} {\partial }_{\tilde{z}} {\tilde{p}}_{h} \\ \tilde{ρ} {\partial }_{t} {\tilde{v}}_{z} = - \frac{\sqrt{1 + 2 \tilde{δ}}}{{\tilde{v}}_{n}} \partial z \frac{{\tilde{p}}_{n}}{\sqrt{1 + 2 \tilde{δ}}} \\ \frac{1}{{\tilde{ρ v}}_{n}^{2}} {\partial }_{t} {\tilde{p}}_{h} = - ( 1 + 2 \tilde{η} ) ( {\partial }_{\tilde{x}} {\tilde{v}}_{x} + {\partial }_{\tilde{y}} {\tilde{v}}_{y} + {\tilde{s}}_{x} {\partial }_{\tilde{z}} {\tilde{v}}_{x} + {\tilde{s}}_{y} {\partial }_{\tilde{z}} {\tilde{v}}_{y} ) - \frac{1}{{\tilde{v}}_{n}} {\partial }_{z} {v}_{z} \\ \frac{1}{{\tilde{ρ v}}_{n}^{2}} {\partial }_{t} {\tilde{p}}_{n} = - ( {\partial }_{\tilde{x}} {\tilde{v}}_{x} + {\partial }_{\tilde{y}} {\tilde{v}}_{y} + {\tilde{s}}_{x} {\partial }_{\tilde{z}} {\tilde{v}}_{x} + {\tilde{s}}_{y} {\partial }_{\tilde{z}} {\tilde{v}}_{y} ) - \frac{1}{{\tilde{v}}_{n}} {\partial }_{z} {v}_{z}\end{matrix} \qquad$$

11. The method of claim 1, wherein the earth model \tilde{m} comprises one or more of the following variables: nmo velocity, reflectivity, η, δ, ε, density, vertical velocity, horizontal velocity.

12. The method of claim 1, wherein the method is used to make an image of a subsurface earth formation.

13. The method of claim 12, wherein the image is a seismic map.

14. The method of claim 13, wherein the subsurface earth formation comprises a hydrocarbon fluid and the seismic map is used to plan, manage and/or optimize the placement of at least one hydrocarbon fluid production well traversing the formation and/or the production of hydrocarbon fluid through the at least one well.
